(19) United States
(12) Patent Application Publication
(10) Pub. No.: US 2018/0165645 A1
(43) Pub. Date: Jun. 14, 2018

(54) SYSTEM AND METHOD FOR A SECURE COLLABORATIVE MEDIA PRESENTATION

(71) Applicant: UR-Take, Inc., Mountain View, CA (US)

(72) Inventor: Genofre Magpayo, Mountain View, CA (US)

(73) Assignee: UR-Take, Inc., Mountain View, CA (US)

(21) Appl. No.: 15/707,630

(22) Filed: Sep. 18, 2017

Related U.S. Application Data
(60) Provisional application No. 62/433,960, filed on Dec. 14, 2016.

(51) Int. Cl. G06Q 10/10; H04N 21/2187; G06Q 50/00; H04L 12/58; H04N 1/00

(52) U.S. Cl. CPC G06Q 10/101; H04N 21/2187; H04N 1/00159; H04L 51/10; G06Q 50/01

(57) ABSTRACT

A process for securely coordinating different image capture devices at an event so that images captured may be vetted and redisplayed for all participants to view in near real-time. The process includes a group of image capture devices, wirelessly communicating to a remote server that is located at the event. The server coordinates the devices in the group, consolidating the captured images from all the devices and presenting them to an event hoster for their approval so that they can be redisplayed to all participants at the event through a display system, which may include one or more of the capture devices.

### CROSS REFERENCE TO RELATED APPLICATIONS

This application claims benefit of U.S. Provisional Application Ser. No. 62/433,960, filed Dec. 14, 2016 and titled “System and Method for a Secure Collaborative Media Presentation”, which application is incorporated by reference herein in its entirety.

### TECHNICAL FIELD

The present invention relates to a system and method for photographing events and more particularly to the capture and consolidation of event photographs by event attendees and the re-displaying of selected photographs to the event attendees in near real-time.

### BACKGROUND

Unless otherwise indicated herein, the approaches described in this section are not prior art to the claims in this application and are not admitted to be prior art by inclusion in this section.

Systems, devices and methods for photographing, video recording and publishing digital contents of events are well known. Pictures and other digital content are captured by event photographers using both film and digital cameras while event attendees commonly use the digital cameras on their mobile phones. Additionally, for events such as a wedding event, disposable film cameras may be distributed with the intention of wedding guests to shoot pictures which are later collected and processed post-event. In the end, a large amount of post-event digital content can be collected from event attendees and other sources which is then stored, organized, published and possibly re-sold (as prints) using cloud storage systems and social media platforms such as Twitter.com, Facebook.com, Shutterfly.com, Snapfish.com and Instagram.com to name a few.

These systems are primarily designed to manipulate and share digital content of an event with the masses. To be a participant of an event that either contributes the digital content as well as consumes the content, these systems require the individual contributors and viewers to register themselves and/or their devices with a system, typically a cloud application, so they can upload and share their images. These pre-requisites as well as the general process of uploading the content can be time-consuming, prone to user error, prone to connectivity issues with the cloud application and can be disruptive to the focus of an event.

Additionally, to participate with these applications, whether contributing or viewing the digital content, users must have their own mobile device and must each register with the application, in turn requiring that each user have a connection to the internet or to their mobile cell provider, and they must be willing to use their device to participate, possibly leading to additional data transfer charges. This can be limiting to hoster(s) of an event that do not want to or cannot provide internet access. Likewise, not every event attendee wants to, or has access to, a mobile device, excluding them from this form of collaboration. Additionally, given the nature of most social media platforms, the digital content being shared is shared globally, leaving open concerns regarding security and privacy of the event. In cases where security and privacy are a concern, mobile devices may be confiscated or disallowed and digital photos are limited to authorized photographers.

Some available systems are designed for the collection, inspection and redistribution of photos after the event. The focus of such inventions being to provide a means for a photographer or photographer service to upload photos to a website where guests can then access them for download, purchase and viewing on their pc or mobile device. These systems are specific to the digital contributions from a selected photographer or the photographer service.

Other available systems allow for an in-event presentation of pre-defined digital content as well as a means for supporting ecommerce of that content while at the event. The focus of such inventions is to provide a center-piece display by which a pre-defined slideshow, video or stream can be broadcast to the table guests and allow them to place orders for copies of the digital content. Pre-captured content is displayed to the event guests during the event and allows them to register, request and purchase personal copies of the content.

Other known systems and methods collect photos and videos via invitations to simplify the steps used in gathering such digital content to create and manage a digital album of the event. The focus of such inventions is to automate the creation of a digital album.

Other known approaches include a wedding ceremony information distribution system for the video capture of wedding ceremonies and the replaying of the video to prescribed destination points during the wedding reception and post-wedding. As with other systems mentioned above, digital content captured during the event by a specific photographer or photographer service can be replayed during the event. Individual users can capture and post pictures on social media, sharing information globally. Post-event, digital captures can be collected by numerous sources for consolidation and organization into an album system for viewing afterwards. For security reasons, some events may not permit the taking of photographs by individual participants.

In short, while social media and other technologies exist to proliferate the sharing of digital content, there are challenges at an event, such as a wedding, to enable all participants at the event to easily partake in the capturing of photographs and displaying these photographs for all participants to view real time. Additionally, if the event hoster wishes to prevent photos of the event from being publicly viewed, then typical social media applications and individual mobile devices for personal photos are disallowed. Finally, with social media and other event applications, the publication of pictures is left to the discretion of the contributor.

Thus, there remains a need for improved systems and methods for secure collaborative media presentations, including a local system for securely coordinating different image capture devices at an event so that images captured may be vetted and redisplayed for all participants to view in near real-time.

### SUMMARY

Described herein are systems and methods for secure collaborative media presentations. Some embodiments relate to a process for securely coordinating different image capture devices at an event so that images captured may be vetted and redisplayed for all participants to view in near real-time. For example, some embodiments include a group of image capture devices, wirelessly communicating to a remote server called a gateway server. The gateway server may coordinate the capture of images from the various capture devices and provide a user interface for a vetting process by which an event hoster can view and select which captured images will be published and displayed to everyone. The hoster maintains the integrity of the event by approving the images for publication and display. In such embodiments, the gateway server may incorporate the approved images into a continuous slideshow that is projected for all participants to view.

In some embodiments, the gateway server may also communicate over a network to one or more remote servers, for example located in the cloud, referred to herein as the hosting server. The hosting server is responsible for the storage of all images captured, management of those images and republication or broadcast of the approved event images for internet consumption purposes. The hosting server can also integrate with existing social media platforms and publish images to these applications as the event hoster requests or allows for the event.

Advantages of a system and method for a secure collaborative media presentation as shown and described herein may include: allowing the attendees of an event to participate in the photographing of the event for the purposes of viewing these pictures as a slideshow, near real-time, by all the attendees; eliminating the requirement for attendees to register their devices or themselves for participation in the digital contribution for the event; allowing the event hoster to vet the contributed photos prior to the display and/or publication of the photos for the purposes of maintaining the integrity of the event; and/or allowing the event hoster to secure the system such that photographs can be taken, collected and displayed during the event, but not allowed to be viewed outside the event unless permitted.

One example of this embodiment would be for a wedding reception. For each of the tables at the reception, one or more capture devices used by the present system may be available. In some embodiments, guests are not required to register with any systems to utilize the devices. Guests are invited to capture photos of the event occurring at their tables at any times through these capture devices. These devices transmit the captured photos to the gateway server where an event hoster decides which images to publish and orders them into the slideshow. Large projection displays are located at one or more areas in the reception. The gateway server projects the slideshow, near real-time, for everyone's viewing, inviting a more collaborative, fun, and memorable event.

In some embodiments, an interactive event media presentation system and method for coordinating the capture of digital images from a plurality of capture devices at an event and redisplaying said images as a continuous slideshow, near real-time to an audience of the event, may be provided. Such system may include a computer system at the event and one or more capture devices having components and software for capturing digital images and wirelessly transmitting the digital images to a server. In some embodiments, the system may allow each capture device to capture digital images and cache them locally, and may allow the user of each capture device to choose which captured images will be transmitted wirelessly to the server. In some embodiments, the system and method may further include the transmitting of metadata such as, time/date of event, ID and GPS location of the capture device for each captured image that is selected for transmittal to the server, and may include a method for the review and selection of captured images on the server, for example wherein the method allows a user that is monitoring the server to review each transmitted digital image and manually select and order which images will be used in the slideshow. In some embodiments, a monitor, digital projector and screen, or other means (e.g., including software instructions) for projecting and/or displaying the slideshow to the audience may be included, for example wherein the means projects the selected images to a large display at the event as well as displaying the selected images back to the capture devices. In some embodiments, systems and methods herein may further include a means for securing a wireless connection between said server and said capture devices, for example wherein the interactive event media presentation system captures and displays said images in near real time. In some embodiments, the capture devices may be mobile computing devices such as tablets and mobile phone devices. In some embodiments, the event may be a physical event at a physical location, a virtual event without a physical location, or a combination thereof. In some embodiments, an interactive event media presentation system in accordance with the present disclosure may interface with online services for the purposes of image storage, image redistribution, and integration with other social media services.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings.

FIG. 1A is a schematic illustration of the overall architecture of a secure collaborative media presentation system at an event, in accordance with an example embodiment.

FIG. 1B is a schematic illustration of functional elements of a gateway server.

FIG. 2 is a schematic illustration of the overall architecture of a collaborative media presentation system supporting an open or virtual event with mobile capture devices, in accordance with an example embodiment.

FIG. 3 is a flow chart depicting example image display logic for execution on each mobile capture device or remote display agent.

FIG. 4A is a flowchart depicting example image capture logic that may be executed on each capture device when taking and submitting pictures.

FIG. 4B is another flowchart depicting image transmittal logic that may be executed on each capture device when taking and submitting pictures in the example embodiment of FIG. 4A.

FIG. 5A is a flowchart depicting image display logic that may be executed on the gateway server in an example embodiment.

FIG. 5B another flowchart depicting capture device request processing logic that may be executed on the gateway server of the example embodiment of FIG. 5A.

FIG. 5C is a flowchart of the image receival logic that is executed on the gateway server of the example embodiment of FIG. 5A.

FIG. 5D is another flowchart of the image vetting logic that is executed on the gateway server of the example embodiment of FIG. 5A.

FIG. 6 illustrates the hardware architecture of a capture device in accordance with an example embodiment.

FIG. 7 is a schematic illustration of an example user interface of a capture device depicting an administrator login screen to configure the device for use in accordance with an example embodiment.

FIG. 8A is a schematic illustration of an example user interface of a capture device depicting a home screen for taking a picture and showing device status.

FIG. 8B is a schematic illustration of the example user interface of the capture device of FIG. 8A, showing a picture taken by the user with selectable options for sharing the photo.

FIG. 8C is a schematic illustration of the example user interface of the capture device and photo of FIG. 8B, indicating that the photo has been shared or submitted back to the hoster.

FIG. 8D is another schematic illustration of the example user interface of the capture device and photo of FIG. 8B, in this case indicating that the photo was not shared.

FIG. 9 is a schematic illustration of the example user interface of the capture device of FIG. 8A, depicting an administrator log in/out screen in accordance with an example embodiment.

FIG. 10 is a schematic illustration of an example UR-Take Manager screen for configuring the local host system for managing an event, in accordance with an example embodiment.

FIG. 11A is a schematic illustration of an example UR-Take Gateway screen of a local host system for vetting and displaying images during an event, in accordance with an example embodiment.

FIG. 11B is a schematic illustration of another view of the example UR-Take Gateway screen of FIG. 11A.

Like reference numerals refer to the same or similar components throughout the several views of the drawings.

### DESCRIPTION OF EMBODIMENTS

### I. Overview

Described herein are systems and methods for providing secure collaborative media presentations. In the following description, for purposes of explanation, numerous examples and specific details are set forth in order to provide a thorough understanding of the aspects of the systems and methods. It will be evident, however, to one skilled in the art that the present invention as defined by the claims may include some or all of the features in these examples alone or in combination with other features described below, and may further include modifications and equivalents of the features and concepts described herein.

### II. Example Embodiments

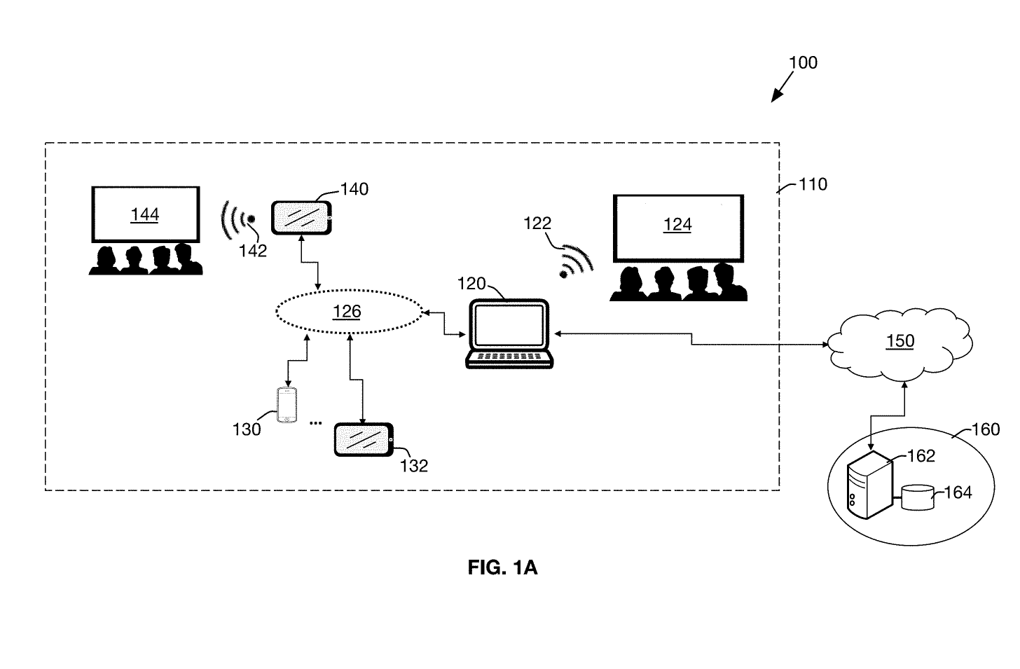

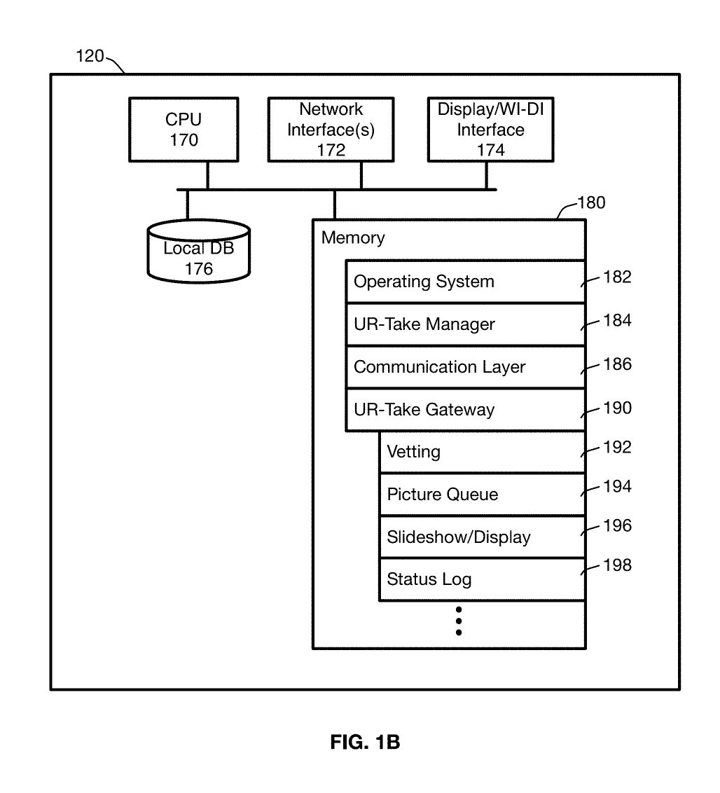

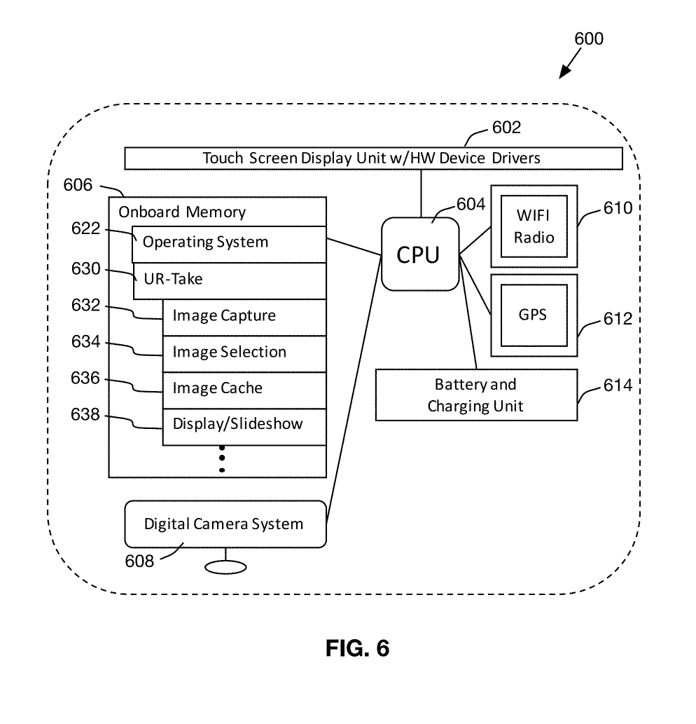

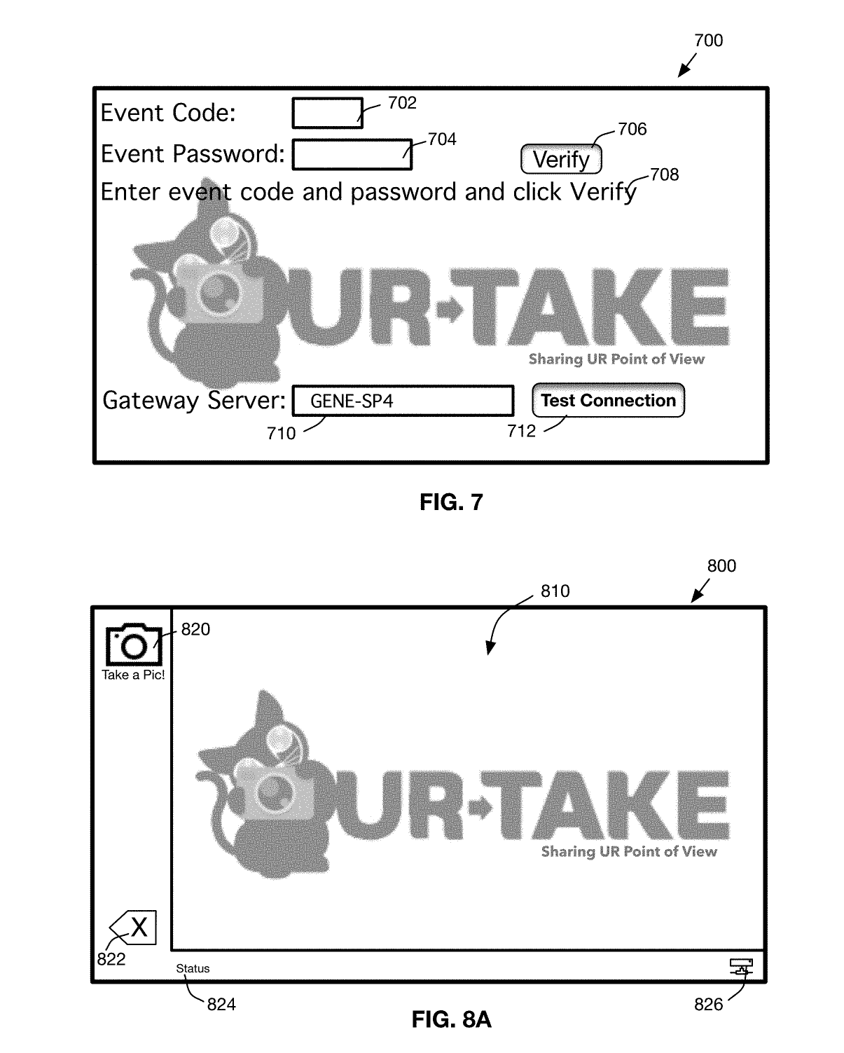

Embodiments of the present system will now be described with reference to FIGS. 1A-5B, which in general relate to a system for coordinating the collaboration and capturing of different image capture devices at an event so that images captured by the devices are consolidated, vetted for publication and then displayed to an audience of the event. The description for FIG. 6 relates to an example hardware embodiment of a capture device that may be employed in the present systems, and FIGS. 7-11B relate to example user interface screens illustrating various features of example capture devices and host/administration systems.

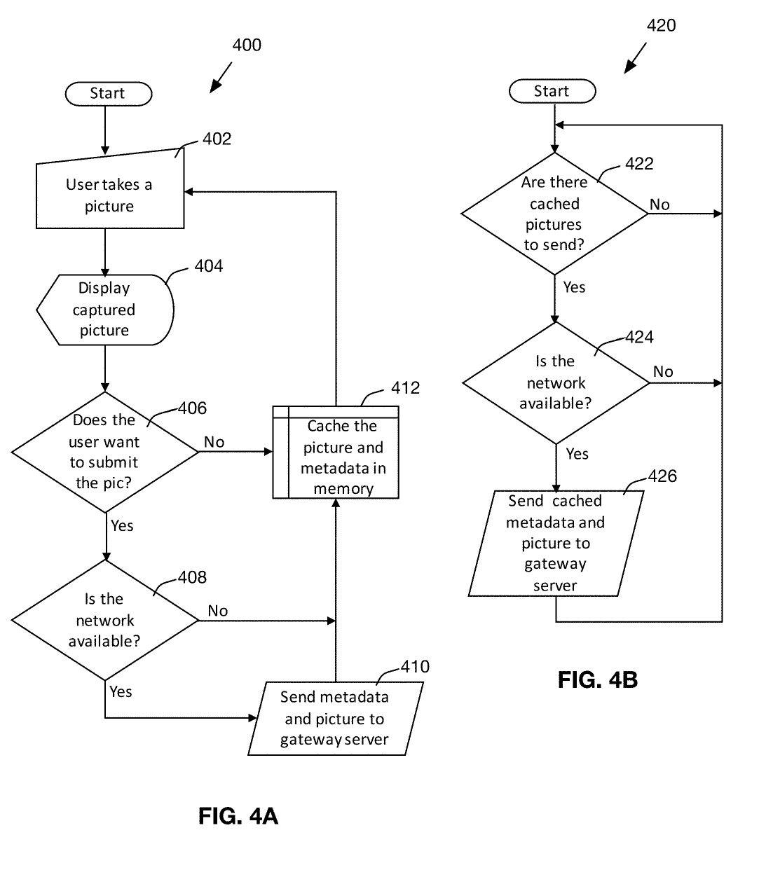

FIG. 1A illustrates the overall architecture of a secure collaborative media presentation system 100 at an event in accordance with an example embodiment. Perimeter 110 is used to indicate a closed or contained event such as a wedding reception, a birthday party, a company meeting or event. Capture devices 130, 132 are devices such as tablets, mobile phones, or other devices capable of capturing pictures as well as executing the capture steps defined in FIGS. 4A-4B. In some embodiments, capture devices 130, 132 may also be used to display photos that have been vetted and “published” to the event by a host. Any desired number of capture devices may be used, e.g., one for each guest at an event. In this example, device 140 may be a tablet, smart phone, or other computer device used as a remote display agent, as described in more detail below.

Each of the capture devices 130, 132, and optionally a remote display agent 140, may be wirelessly connected over a secure local wireless area network (WAN) 126 to a server 120, also referred to herein as a local host and/or as gateway server 120. The WAN can be comprised of a local wireless router along with additional wireless access points (WAPs) as needed. The WAN 126 may be secured against unpermitted external wireless devices through a combination of router security processes ranging from the use of a non-broadcasted service set id (SSID) to encrypting connections with security options such as Wi-Fi Protected Access 2—Pre-Shared Key (WPA2-PSK) and Media Access Control (MAC) address filtering.

Gateway server 120 may be connected to the WAN 126 and sits between the capture devices 130, 132 and one or more large display systems or devices 124. The gateway server 120 hosts a local database to store and manage captured images transmitted from the capture devices. It allows the event hoster to choose which contributed images will be selected for the event slideshow as explained in FIG. 4A. The gateway server 120 also transmits and projects approved images over a wireless display (WI-DI) connection 122, an HDMI connection, or other wired or wireless communication protocol to display device 124. In some embodiments, display device 124 may comprise a large flat screen display or array of displays, a projection system, and/or other systems for displaying digital images and/or video to an audience at an event. In some embodiments, the gateway server 120 may also send images or video through local WAN 126 or other wired or wireless communication protocol to one or more remote display agents 140, each of which may communicate, for example through a WI-DI or other connection 142, to a second display, or remote display 144. In some embodiments, server 120 may also send images back to the capture devices 130, 132 for display on each device.

In some embodiments, a system and method for secure collaborative media presentation 100 may include a server 120 configured to communicate over a local network 126 with one or more capture devices 130, 132 to receive images, video or other media (collectively, “media”) captured by the capture devices 130, 132 at an event. The server 120 may also communicate with one or more display devices to display the received media. As used herein the term “display system” may include one or more of any combination of display devices, and the term “display device” may be any of primary display 124, one or more display agents 140, each of which may include an integrated screen for displaying media and/or a communication interface for displaying the media on a remote display 144, and one or more capture devices 130, 132. Additionally, all communications (e.g., between server 120 and capture devices 130, 132, display 124, agents 140, and/or hosted server 162 as described below) may be encrypted both in transit and at rest.

In some embodiments, the gateway server 120 can operate in two modes: (1) connected to the internet 150; or (2) in a disconnected mode from the internet. When connected to the internet 150, the gateway server may interface with a hosted system 160, including for example a server 162 which manages user profile information and event information, and a hosted database 164 in communication with the server 162 storing captured images. When disconnected from the internet, the gateway server 120 may serve as a hosted server until it is connected to the internet and can communicate with the hosted server 162.

FIG. 1B is a schematic illustration of a gateway server 120, or local event server, including various components and functional modules in accordance with an example embodiment. For example, server 120 may include a CPU or processor 170 for controlling overall operation of the system, a network interface 172 for communicating over one or more networks (e.g., WAN 126 and/or Internet 150), and a memory 180 for storing information and instructions for performing various operations as described herein. In some embodiments, server 120 may also include a display interface 174, e.g., for 1-to-1 or other secure communication with display device 124. In some embodiments, communication with one or more display devices or display systems may be performed utilizing one or more display interface(s) 174 and/or network interface(s) 172. In some embodiments, server 120 may also include one or more local databases 176, e.g., for storing media, presentations, user information, or other information or data. In some embodiments, local DB 176 may be part of memory 180.

Memory 180 may include information, programs, and/or instructions for performing various actions or processes, shown and described herein for the sake of convenience as functional modules. For example, in some embodiments memory 180 may include an operating system 182, configuration module 184 (shown here as UR-Take Manager 184), a communication layer 186, and media administration system 190 (shown here as UR-Take Gateway 190). Operating system 182 may include information and instructions for overall operating of server 120 and its various hardware and software components. UR-Take Manager 190 may include information and instructions for configuring the server 120 for use at a particular event, e.g. by communicating with hosted server 162 over Internet 150 prior to an event to download event details and other information needed for operation of the server 120 and other elements of system 100 at the event and/or following an event to upload captured images, media, event details, or other information to the hosted server 162. Communication layer 186 may be configured and used for communicating with and/or configuring capture devices 130, 132 and/or agents 140, for example to receive pictures captured and shared by event attendees using the capture devices 130, 132 and/or to display vetted pictures on one or more desired display devices at the event.

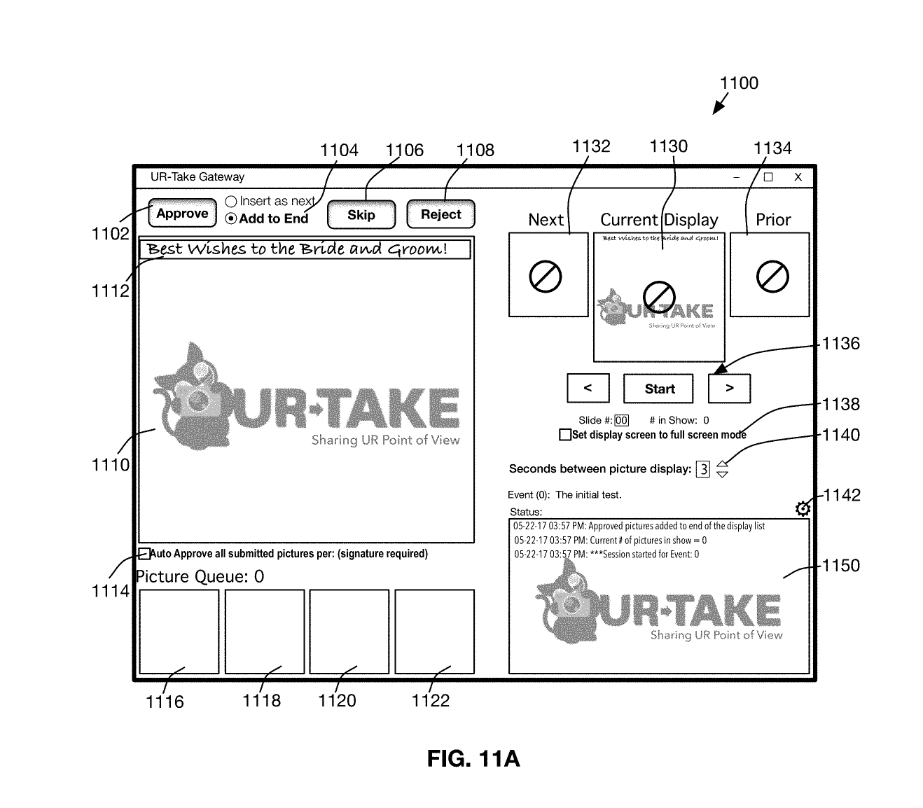

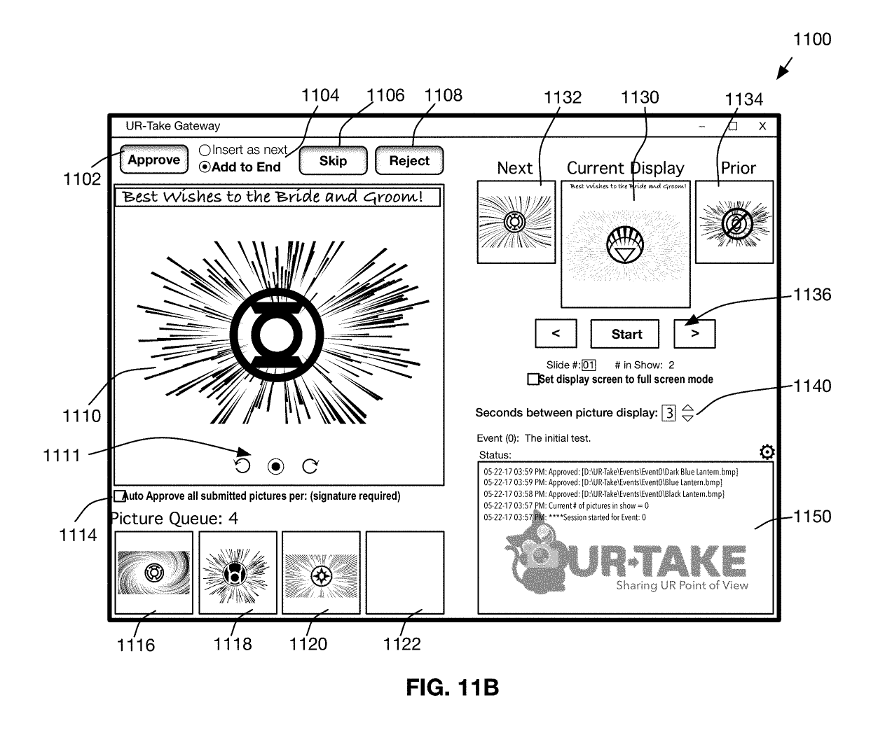

In some embodiments, the media administration system, or UR-Take Gateway 190, may include information and instructions for processing photographs or other media captured at an event, including for example receiving digital photographs from capture devices 130, 132, vetting the photographs to select those to be displayed, configuring a slideshow or other presentation of the photographs, and displaying the photographs on a display system at the event. Example functional modules may include a vetting module 192 for use by an event administrator, or hoster, to view and select from the pictures or other media shared by attendees, a picture queue 194 for holding and/or organizing the media to be vetted and/or displayed, a slideshow module 196 for configuring a slideshow of the pictures/media to be displayed at the event, and a status log 198 for logging actions and showing status of the gateway server 120. Example operation of UR-Take Gateway 190 is shown and described in more detail below with respect to FIG. 11A and FIG. 11B.

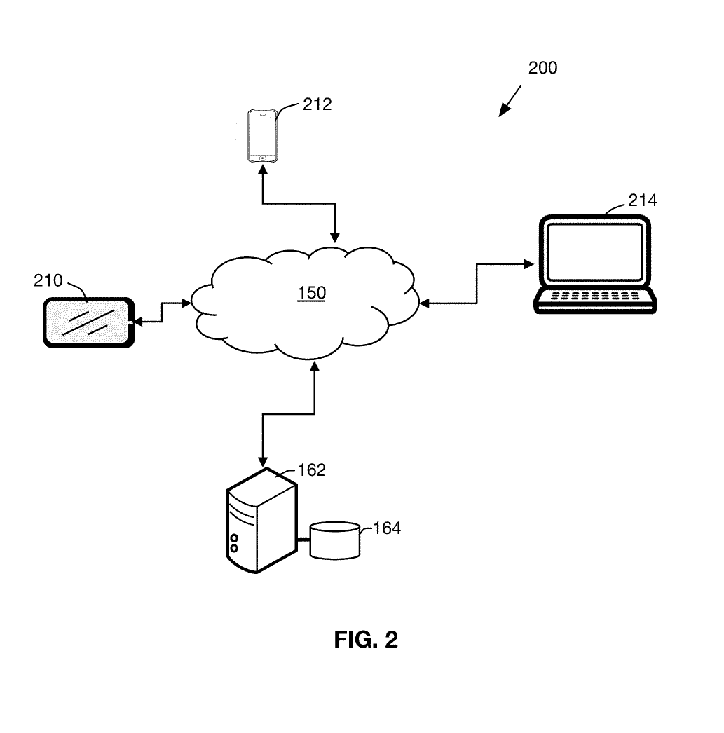

FIG. 2 illustrates the overall architecture of an example collaborative media presentation system 200 for a virtual event where the event has no physical location and is open to various mobile devices connecting over the internet 150. Devices such as tablets 210, mobile phones 212, and laptops and PCs 214 connect over open network connections such as mobile service providers, open wireless networks, or direct connection to the internet to act as capture devices for the virtual event. The tablets, mobile phones, and laptops communicate with an internet service provided by a hosted server 162 and its hosted database 164, to contribute captured images and view approved images from other capture devices. In this embodiment, the network used in the event is not secured against external devices allowing all published images to be made available to a plurality of capture devices. Using a laptop 214 or other compute device that is connected to the hosted server 162 allows an event hoster to vet the contributed images from the various capture devices and select which images will be published as part of the event slideshow.

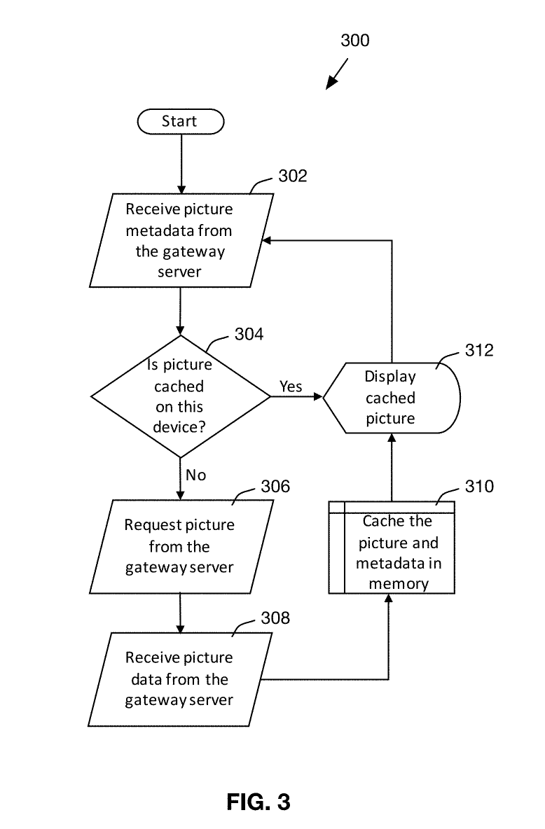

Example methods used by capture devices 130 and 132 to capture digital images, transmit them to the gateway server 120 and display published images sent from the gateway server are described with reference to the flowcharts of FIGS. 3, 4A, and 4B.

For example, event display process 300 of FIG. 3 may be a background process running on a remote display device, such as agent 140, and is connected to the gateway server 120, waits to receive 302 a notification from the gateway server that a picture should be displayed, e.g., on the agent/tablet 140 screen or on an associated remote display 144 controlled by the agent 140 over a 1 to 1 wireless link 142. In step 304 the background process checks to see if that image already exists in its local memory cache. If the image is in cache, then the picture is displayed as indicated in step 312 else the background process must request the gateway server to send the picture to the agent as indicated in step 306. In step 308 the process receives the picture and in step 310 the process caches the picture and its metadata in local memory. The picture is then displayed on the agent to display per step 312. In this embodiment, caching the picture and its metadata local to the capture device increases performance of the display activity and minimizes the amount of communication between the agent/display devices and the gateway server as the continuous slideshow is looped and pictures are redisplayed. In some embodiments, one or more capture devices may be configured to receive and display images as described above, e.g., instead of or in addition to the remote display agent.

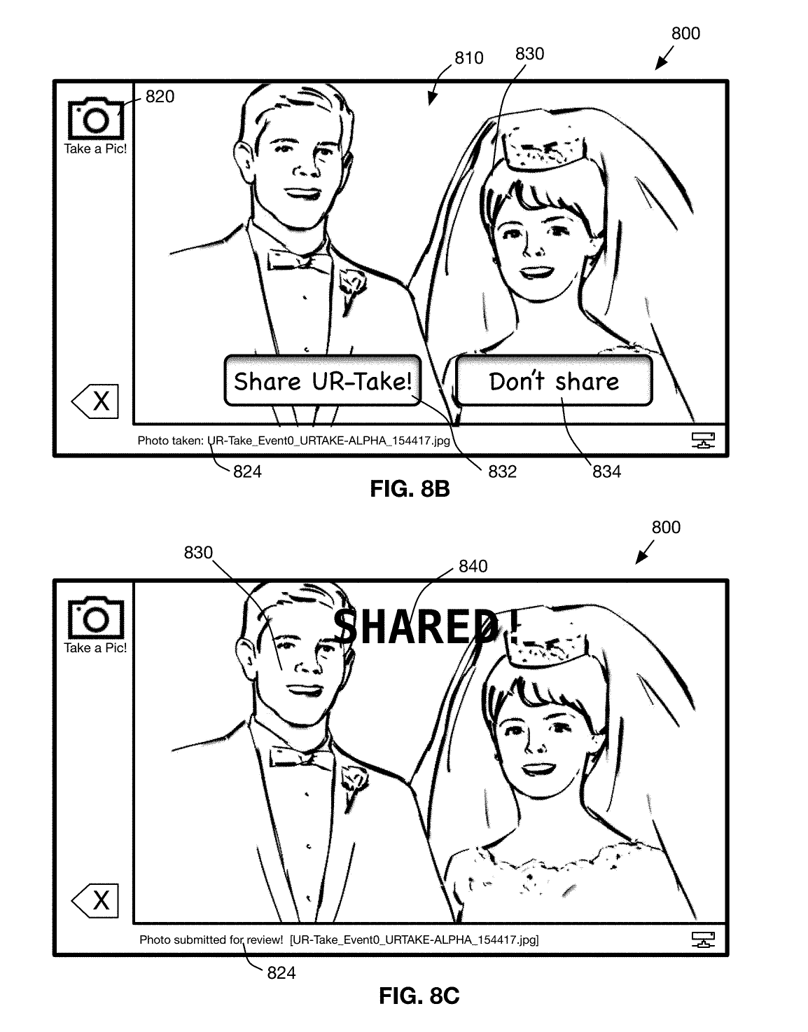

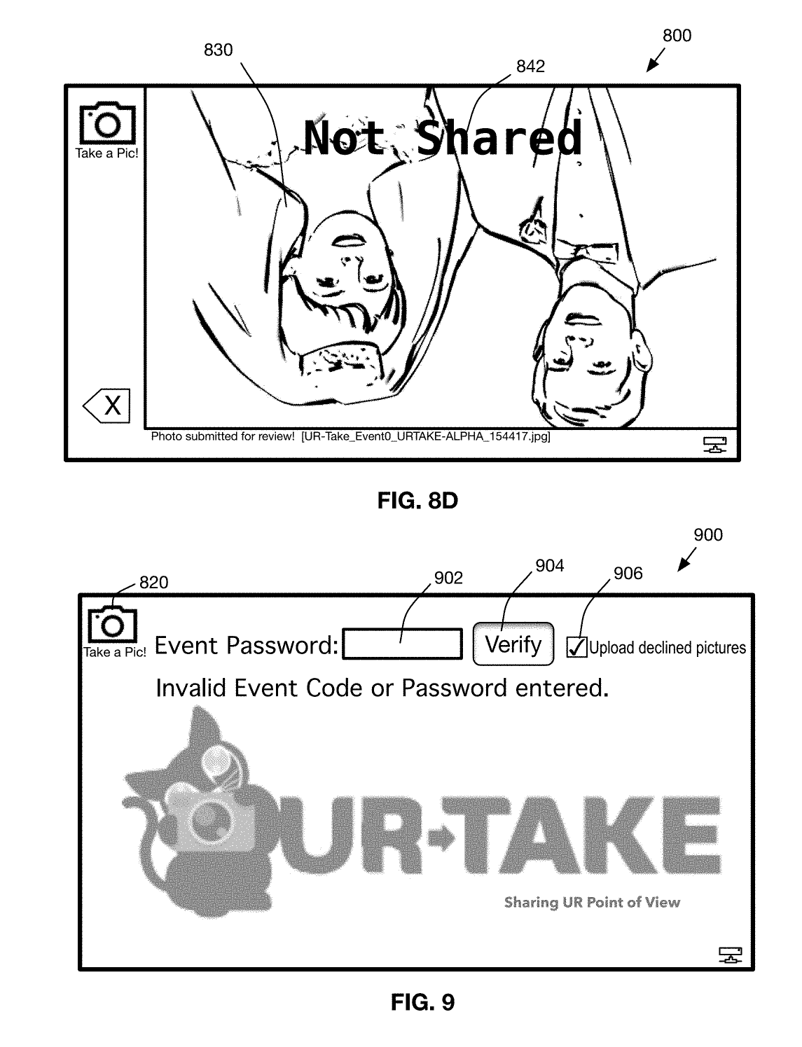

FIGS. 4A and 4B show example methods 400 and 420, respectively, for image capture processing in a capture device. For example, in step 402 a user takes a picture with the capture device (e.g., device 130 or 132), and the captured picture is displayed 404, for example on the screen of the capture device as shown and described below with respect to FIG. 8A to 8D. The user may have the option to submit the picture to the gateway server (e.g., to server 120 of FIG. 1A over local network 126) in step 406. If the user desires to submit the picture, the system may first check to confirm the network is available 408 before sending metadata and picture to the gateway server in step 410. If the user indicates that he or she does not want to submit the picture in step 406, or if the network is unavailable in step 408, the picture and metadata may be cached in local memory in step 412.

Another background process 420 running on the capture device may be used to process the local cache of pictures mentioned in step 412 of method 400. In step 422 of FIG. 4B, the process checks to see if any cached images should be sent to the gateway server 120. If there are no images to be sent then the process waits until notified else it executes step 424 and checks to see if the connection to gateway server is available. If the connection is available then step 426 is executed to send the picture and its metadata to the gateway server else the process returns to step 422 where it waits to see if other images should be processed. Should the network and/or the connection to the gateway server be unavailable, it is not without reason that this process could wait on a notification that the connection is available before processing any pictures. In this manner, step 424 may be executed before step 422 possibly preventing a CPU intensive execution loop.

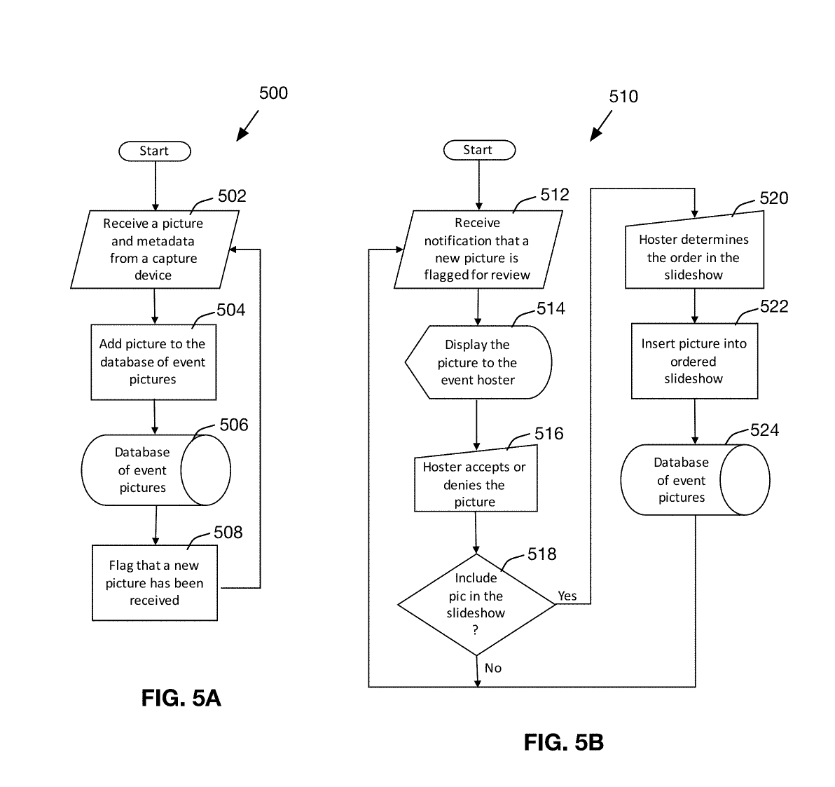

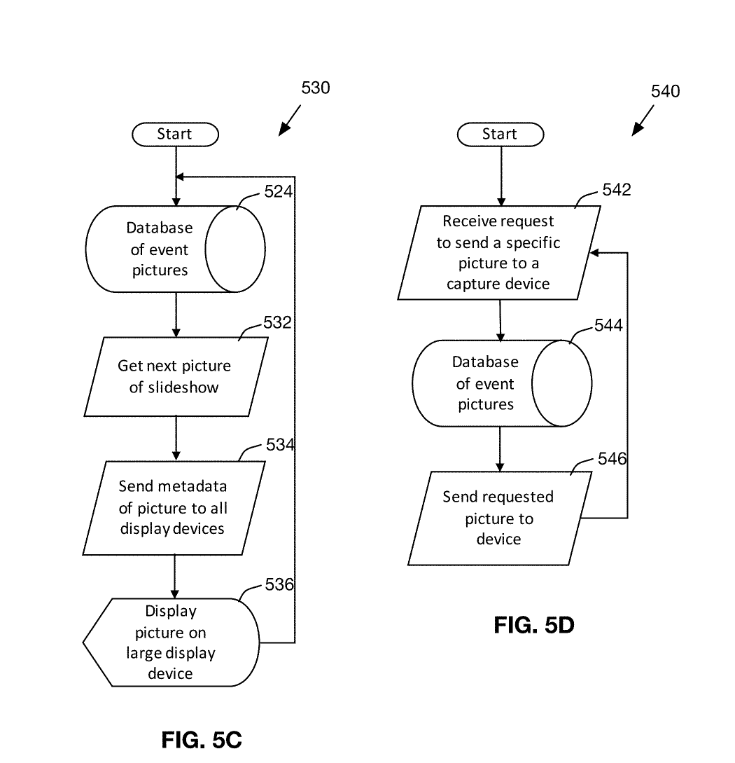

Some methods that may be used by gateway server 120 to vet captured digital images and transmit selected images to a large display 124, to remote displays 144 (e.g., through a remote agent 140 of FIG. 1A), and/or in some embodiments back to the capture devices 130, 132, are described below with reference to the flowcharts of FIGS. 5A, 5B, 5C, and 5D.

Method 500 is an example method for a gateway server to flag a new picture or other media for review by an event host or administrator (also referred to herein as a “hoster”). In step 502, a background process running on the gateway server 120 receives a captured image sent from a capture device such as tablet 130. The received image is the result of the execution of step 410 of FIG. 4A or step 426 of FIG. 4B. Steps 504 and 506 indicate that the gateway server may store the received image and its metadata in a local database containing all the captured images submitted for display at the event. Step 508 sets a notification or flag that a new captured image has been received. In this example method 500, background process 502 then waits for a next image to be received.

FIG. 5B provides an example method of vetting pictures to be displayed in a slideshow at an event. In step 512, another background process running on the gateway server 120 receives the notification that a new image is stored in the local database. Step 514 indicates that the new image is displayed to the event hoster monitoring the gateway server at the event (e.g., via a UR-Take Gateway interface with vetting features such as shown and described below with respect to FIGS. 11A and 11B). In step 516 the event hoster manually decides whether the new picture will be accepted for display to the audience at the event, e.g., on display device 124 and/or one or more remote agent/displays 144, or other devices in communication with the gateway 120. In some embodiments, pictures and/or a vetted slideshow may be displayed on one or more of the capture devices. If the picture is declined in step 518 then the process returns to step 512 and waits on another notification else in step 520 the event hoster is prompted to manually indicate where in the slideshow the accepted image should be inserted. Steps 522 and 524 indicate that the image is inserted into the slideshow and updated in the database of event pictures. The process then returns to step 512 and waits on another notification. Example gateway server user interface screens for implementing this example vetting method are shown in FIGS. 11A and 11B and described in more detail below.

One skilled in the art will appreciate that, in some embodiments, computer machine learning and predictive analytics techniques may be used to automate the vetting process of the event pictures. In some embodiments, systems and methods described herein could integrate with machine learning processes using predictive analytics to automate the manual processing of steps 516-524, for example. This integration could occur, for example, through programmatic application interfaces.

An example method 530 of displaying vetted pictures is shown in FIG. 5C. Step 524 may be another background process running on the gateway server 120, responsible for looping through all the published or accepted pictures stored in the local database of event pictures. The process loops through the slideshow of pictures and in step 532 pulls each picture to be displayed. In some embodiments, step 534 may send a notification and the metadata of the picture to be displayed to each display device, which may include one or more remote display agents 140 (e.g., to be shown on the agent 140 screen or display 144), and/or one or more capture devices 130, 132. Step 536 indicates that the gateway server may then presents the slideshow picture to the audience at the event, e.g., through one or more of the display devices.

Method 540 of FIG. 5D illustrates a process for providing a requested picture to a capture device in accordance with an example embodiment. For example, in step 542, another background process running on the gateway server 120 may be responsible for receiving requests sent from capture devices to send the image data to be displayed. The request may be generated as explained in step 306 of FIG. 3A. Steps 544 to 546 pull the requested image from the local database on the gateway server and send the image back to the requesting capture device.

An example capture device 600 is shown in FIG. 6, including a schematic illustration of its hardware architecture in an example embodiment. In some embodiments, device 600 may be used in system 100 as capture devices 130 and/or 132. Device 600 may be a self-contained hardware device capable of executing the steps shown in FIG. 3, FIG. 4A, FIG. 4B. The device 600 may be a fully contained, handheld unit, which may include a touch screen display 602 for input/output functionality. The display 602 may be driven by device drivers and a capture unit CPU 604, which may be configured to execute instructions such as those described above with respect to FIGS. 4A and 4B. Onboard memory 606 may support the CPU for storage and execution of the operating system 622 and processing modules (e.g., UR-Take 630 for performing processes described herein) as well as the storage of images captured by the digital camera system 608. Onboard memory 606 may also be used for the storage of display images and metadata described with respect to FIG. 3. A WIFI radio 610 or other wireless communication interface may provide wireless communication of the device, for example over a local network such as WAN 126 of FIG. 1A or other communication with Gateway server 120 and/or other devices using desired wireless protocols. In some embodiments, a GPS module, or chip 612, may also be incorporated within the capture device to provide location metadata for each picture taken. The GPS module 612 may also be used to track the location of each capture device unit. A Battery 614 and charging mechanism, and/or other power supply, may be used to power the self-contained unit 600.

In some embodiments, a UR-Take application 630 or processing module may include one or more functional modules having instructions or information for desired operations, such as image capture 632 for capturing photographs or other media at an event, image selection 634 for selecting and sharing captured photographs with the gateway server 120 (e.g., to be vetted by hoster and displayed at the event), and image cache 636 for storing captured photographs and/or metadata. In some embodiments, device 600 may include a display/slideshow 638 module for displaying a slideshow or other media sent by the gateway server 120.

As used herein, the term “event” may refer to any setting where one or more capture devices are present to capture images of the event. An event may be a social or recreational occasion such as a wedding, party, vacation, concert, sporting event, etc., where people gather together at the same place and same time and take photos and videos. An event may also be virtual where no physical location is defined for the event and one or more capture devices participate to capture digital images.

In some embodiments, an aspect of the capture device may be its non-requirement for a user to register with the gateway server. At a closed event, for example, capture devices are known by the gateway server before the start of the event. The capture devices may be pre-registered with the gateway server and are the only capture devices allowed to participate in the event. Such an arrangement may greatly simplify use of the system by event attendees, allowing any user to operate a capture device without the need for the user to register at the event or prior to the event. At a secured event, allowing only specified registered capture devices may be critical to preventing data leakage.

Turning now to FIGS. 7-9, schematic illustrations of example user interfaces of a capture device are shown in accordance with an example embodiment. For example, FIG. 7 is a schematic illustration of a configuration screen 700 that may be used, for example, to pre-register a capture device with the gateway server prior to an event as described above. Such an interface screen 700 may include various fields, buttons, and other features for inputting information and/or configuring the device, for example an Event Code input field 702 and an Event Password field 704 for configuring the device for use at a particular event. A Verify button 706 or other feature may be used to submit information entered in the field 702, 704. Instructions 708 or other information (e.g., regarding status of the device or a request) may also be provided. A Gateway Server field 710 may be used to connect the capture device with a desired server, e.g., gateway server 120 of system 100. A Test Connection button 712 or other feature may be used to submit the entered server information.

FIG. 8A is a schematic illustration of an example image capture screen 800 of a capture device (e.g., device 130, 132, and/or 600). Screen may include a main viewing area 810, e.g., to show a scene or object to be photographed by a user and/or to display pictures or video captured by the device (and/or images or video delivered to the device from the gateway server). Buttons or other selectable features may include Take a Pic 820 and screen navigation 822. Other displayed information or features may include a status bar 824, e.g., for showing the status of the device and/or of an image taken, and/or a connection indicator 824 or other feature to show the network connection status (or in some embodiments power level) of the device.

In FIG. 8B is another view of the example image capture screen or interface 800, showing an image 830 captured with the device 600. Status bar 824 may show a status of the device, such as “Photo taken: [filename]”, or other information related to the image, actions taken (or to be taken), and/or the device status. Selection boxes, buttons or other selection features 832, 834 may be employed to allow the user to “share” 832 or “don't share” 834 the image 830.

FIG. 8C shows an example screen 800 following selection by the use of Share UR-Take! 832 in FIG. 8B, showing that the image 830 has been “Shared” 840 with the gateway server. In such embodiments, the shared photo(s) may be viewed, vetted, and or/processed by a hoster or other administrator, e.g., using the local gateway server at the event.

FIG. 8D is an example screenshot illustration informing the user that the image 830 from FIG. 8B has been “Not Shared” 842 (e.g., following selecting the “don't share” button 834 in FIG. 8B). In some embodiments, in response to an election by a user to not share an image, the image may be inverted (as shown in FIG. 8D), greyed out, or otherwise marked to indicate that it has been viewed and selected for not sharing.

FIG. 9 is another schematic illustration of an example user interface of the capture device 800 showing an administrator logout or reset/configuration screen requiring entry of password (and/or an event code, username, and/or other security information) into a field 902. A Verify button or other feature may be used to submit information entered in the field 902. In some embodiments, screen 900 may include an option to elect whether to upload declined pictures (or a subset of the declined pictures cached or otherwise stored in memory), e.g., to the gateway server or other location, before the device is reset or reconfigured.

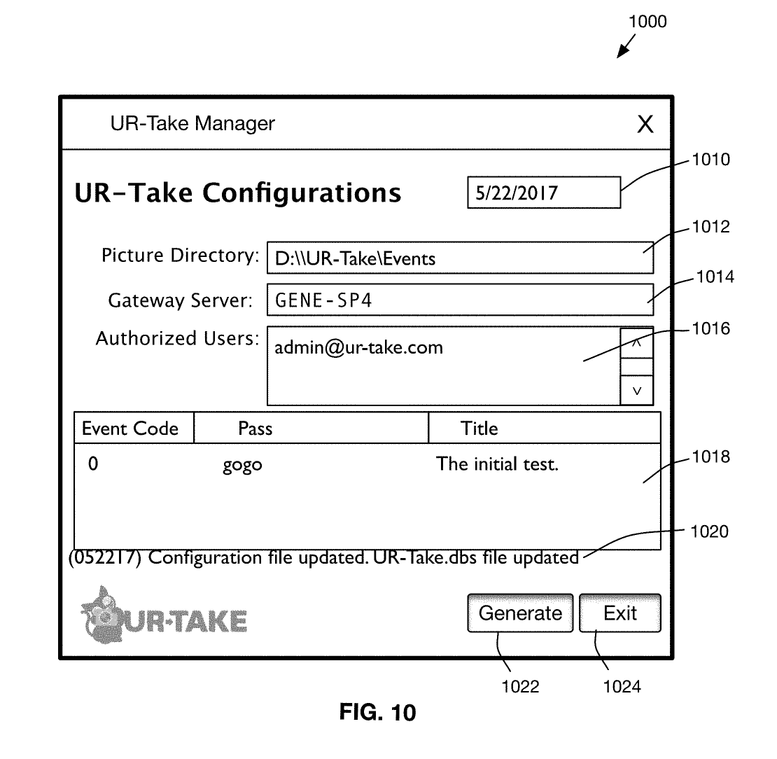

FIG. 10 is a schematic illustration of an example UR-Take Manager screen 1000 for configuring the gateway server 120 or local event server for managing an event. In this example, UR-Take Manager screen 1000 may be used to input information into the gateway server 120 to communicate with hosted server 162 over the Internet 150. Such communication may be used to configure the gateway server for an upcoming event, e.g., by creating a local database from the hosted server database, downloading processing instructions or other software modules or updates, etc. Communication with the hosted server may also be used to upload images, video, slideshows, or other media or materials from an event to the hosted server and/or other locations via the internet. In some embodiments, a UR-Take Manager screen 1000 may include fields for entering or viewing information such as date 1010, a picture directory 1012, gateway server 1014, authorized users 1016. Other information may include event code process information 1018 and/or a status line for showing the status of a request or activity. Buttons or other user input features may also be used to enter commands, such as Generate 1022 and Exit 1024.

In some embodiments, pre-configuring the gateway server with instructions and data required for communicating with and controlling all capture devices, agents, and display devices during an event allows for a closed, secure network during an event. For example, with reference to FIG. 1A, once configured using information from the hosted server 162 and hosted database 164, gateway server 120 may be disconnected from the internet 150 and communicate during the event only over WAN 126 (or other local wireless protocol) with capture devices 130, 132 and remote display agent(s) 140 and/or using WI-DI (or other local wireless protocol) with display device 124. In other embodiments, gateway server 120 may communicate over the internet, cellular service, or other wired or wireless network during an event.

FIGS. 11A and 11B are schematic illustrations of an example user interface screen 1100 for a media administration system (e.g., UR-Take Gateway 190) of a local event server (e.g., gateway server 120 of FIG. 1A). UR-Take Gateway screen 1100 is configured to provide an event hoster or administrator with the ability to view, vet, configure, and display images or other media during an event. Screen 1100 may include various functional areas or features for displaying and inputting information to the user. For example, a main vetting area 1110 may be configured to display submitted images for approval by the hoster, and may include features for adding captions 1112 or other text, icons, comments, emotes, rankings, etc. as desired to each picture. In some embodiments, a hoster or administrator can approve or reject each picture, e.g., approve by selecting the “Approve” button 1102 and indicating an insertion placement option 1104, e.g., to insert the image as the next slide or at the end. A “Skip” button 1106 may be used to skip a picture for later vetting, and a “Reject” button 1108 may be used to reject a picture such that it is not included in the slideshow or otherwise displayed at the event. In some embodiments, rejecting a picture may delete it from the system. In some embodiments, rejecting a picture may move the picture to a rejected folder, trash folder, or other location. In some embodiments, the system may include an “Auto Approve” feature 1114, for example a box, button, or other feature that may be selected by a user to automatically approve all, or a subset, of pictures submitted to the gateway by the capture devices.

In some embodiments, a user may be able to drag and drop pictures to or from a picture queue 1116, 1118, 1120, 1122, or otherwise selecting or rejecting the picture. In some embodiments, other buttons or other selection or navigation features 1111 (of FIG. 11B) may be used to navigate through the submitted pictures, rotate the pictures, and/or to add transitions such as fades and wipes to the pictures.

In some embodiments, an administrator may incorporate pictures, video, graphics, or other media from other types of devices or sources. For example, a closed, secure gateway server system or other local administrator as described herein may receive photos or other content from the personal cell phone or mobile device of an attendee, or from a source outside the event. For example, media may be dropped into a secure repository, for example by near field communication, or “tap to share” technology, or using an external storage facility such as Dropbox, Google Drive, OneDrive, Box.com, or other cloud storage or sharing service accessible over the Internet or other network. In some embodiments, media may be received by an interactive media presentation system as described herein using one or more other wireless networks and/or communication protocols, such as, for example Bluetooth, MMS, SMS, AirDrop, WiFi, local area network, cell phone network, or the Internet. In some embodiments, the term “capture device” as used herein may include any hand-held capture device 130, 132, 600 as shown and described above, and/or may include personal cell phones, tablets, or other mobile devices. In some embodiments, the capture devices may include one or more stationary systems, such as a photo booth or other photography or video apparatus or systems.

Other features include a current display area 1130 for showing the picture that is currently being displayed to the event audience, as well as the next 1132 and prior 1134 images. Control features 1136 allow a hoster to start/stop and skip forward and reverse through pictures, to configure delays between pictures 1140; to dynamically cancel a picture so it is not displayed; to rotate, scale or edit pictures; to set transitions between pictures, e.g., wipe, fade in, fade out, dissolve, cuts, etc.; to change view 1138, e.g., to full screen mode; to add audio, captions, emojis, symbols, or other media features; or make other changes to a slideshow or image presentation as desired. A settings menu 1142 may be used to configure additional features or aspects of the system as desired. In some embodiments, a status area 1150 may include status updates, activity log, or other information.

One skilled in the art will appreciate that while many embodiments shown and described herein utilize digital pictures, or photographs, as an example media, the systems and methods herein may be used for capturing, sharing, vetting, editing, and/or displaying any media, including for example photographs, artwork, graphics, presentation materials, video, audio, or any other desired media.

### III. Conclusion

The foregoing description illustrates various embodiments along with examples of how aspects of the systems may be implemented. The above examples and embodiments should not be deemed to be the only embodiments, and are presented to illustrate the flexibility and advantages of the systems and methods. In the figures, similar symbols typically identify similar components, unless context dictates otherwise. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the sequence diagrams and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the diagrams, scenarios, and flow charts discussed herein, and these diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). Functional aspects described as modules need not be arranged or stored as a unit, and may include instructions, routines or program code distributed, stored and executed in any manner. The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, flash memory, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All citations and references, including without limitation references to web sites, are incorporated by reference herein in their entireties as if fully set out within the application.

What is claimed is:

1. An interactive event media presentation system, comprising:
a server configured to communicate over a local network;
a plurality of capture devices, each capture device including a camera for capturing digital images at an event and configured to transmit the digital images to the server over the network; and
a display system configured to display a presentation received from the server during the event,
wherein said server includes a media processing system for selecting approved images from the digital images received from said plurality of capture devices, configuring a presentation using the approved images, and displaying the presentation through said display system in near real-time to attendees of the event.

2. The interactive event media presentation system of claim 1, wherein each of said plurality of capture devices is a wireless mobile device and further includes:
a memory for caching each of the digital images captured by that capture device,
a touch screen for displaying the captured digital images, and
an image selection module configured to enable a user to choose one or more selected images of the captured digital images for transmitting to said server.

3. The interactive media presentation system of claim 2, wherein each of the capture devices further includes a GPS module for tracking location of the capture device.

4. The interactive media presentation system of claim 3, wherein transmitting the selected images to the server comprises transmitting metadata associated with each of the one or more selected images.

5. The interactive media presentation system of claim 4, wherein the metadata includes any of a date of the event, a time of the event, an event ID, and a GPS location of the capture device.

6. The interactive media presentation system of claim 1, wherein the presentation is a slideshow and configuring the presentation comprises inserting each approved image into a desired location within the slideshow during the event.

7. The interactive media presentation system of claim 1, wherein the display system comprises a primary display device configured to communicate with the server over a wireless display connection.

8. The interactive media presentation system of claim 7, wherein the display system further comprises one or more remote display agents.

9. The interactive media presentation system of claim 8, wherein the display system further comprises the plurality of capture devices.

10. The interactive media presentation system of claim 1, further comprising a hosted server system for managing user profile information and event information, and wherein the server further comprises a configuration module for communicating with the hosted server system to configure the server before the event.

11. An interactive event media presentation system for coordinating the capture of digital images an event and redisplaying the images as a continuous slideshow, near real-time to an audience of the event, the system comprising:
a computer server at the event, said server comprising a memory for storing media administration software and a communications interface for communicating over a secure wireless network with a plurality of capture devices;
said plurality of capture devices, each including a camera for capturing digital images and a memory, wherein the memory includes computer-executable instructions for:
capturing the digital images and caching them locally,
presenting the captured digital images to a user of the capture device and allowing the user to choose selected images of the captured images to be transmitted to the server, and
transmitting wirelessly over a secured wireless network to the server the selected images and metadata associated with each of the selected images, wherein the metadata includes any of a date of the event, a time of the event, an ID of the event, and a GPS location of the capture device; and
a display system for displaying a slideshow of the selected to an audience at the event,
wherein said media administration software includes computer executable instructions for receiving the selected images and metadata, presenting the selected images for review by an administrator of the event, configuring a slideshow using vetted images and input parameters from the administrator, and displaying the slideshow to the audience over said display system during the event.

12. The interactive media presentation system of claim 11, wherein said capture devices are any of, mobile computing devices, tablets, and mobile phone devices.

13. The interactive media presentation system of claim 11, wherein said event is a physical event at a physical location, a virtual event without a physical location, or a combination thereof.

14. The interactive media presentation system of claim 11, wherein said display system comprises a primary display device configured to communicate with the server over a wireless display connection.

15. The interactive media presentation system of claim 14, wherein said display system further comprises one or more remote display agents.

16. The interactive media presentation system of claim 15, wherein said display system further comprises said plurality of capture devices.

17. The interactive media presentation system of claim 11, wherein the server is configured to interface with online services for the purposes of image storage, image redistribution, and integration with social media services.

18. A method, comprising:
capturing a digital image at an event using a capture device communicating over a network to a local server;
presenting the digital image to a user of the capture device for review;
receiving input from the user to designate that the captured image is approved for transfer to said server;
transmitting the approved image and corresponding metadata to the server;
receiving at the server the approved image;
presenting the approved image to an administrator for consideration by the administrator at the event;
receiving input from the administrator to incorporate the image into a slideshow along with other digital images received by other capture devices at the event; and
transmitting wirelessly the slideshow from the server to a display system for display to an audience at the event.

19. The method of claim 18, wherein the corresponding metadata comprises any of a date of the event, a time of the event, an event ID, and a GPS location of the capture device.

20. The method of claim 19, wherein the display system comprises one or more of a primary display device configured to communicate with the server over a wireless display connection, a plurality of remote display agents, and a plurality of the capture devices.
